(19) United States
(12) Patent Application Publication
(10) Pub. No.: US 2010/0284395 A1
(43) Pub. Date: Nov. 11, 2010

(54) Method and apparatus for frame selection

(76) Inventors: James M. Kubik, Lombard, IL (US); Jeffrey A. Hiltner, Winfield, IL (US); Donald A. Schumann, Naperville, IL (US); Alan H. Matten, Chicago, IL (US); Diana L. Lorenz, Naperville, IL (US); Yu Zhou, Naperville, IL (US)

Correspondence Address: Alcatel-Lucent USA Inc., Docket Administrator - Room 2F-192, 600-700 Mountain Ave., Murray Hill, NJ, 07974-0636, US

(21) Appl. No.: 12/387,910

(22) Filed: May 8, 2009

(51) Int. Cl. H04L 12/66

(52) U.S. Cl. 370/352

(57) ABSTRACT

To address the need for new techniques that are able to reduce delays in frame selection, a method such as that depicted in diagram 10 of FIG. 1 may be employed. A packet from one call leg active for a call is received (11) during a particular frame interval of the call. In response to receiving the packet, a determination (12) is made as to whether to make a frame selection decision for the frame interval. This determination is based upon the number of call legs active for the call and upon the number of call legs for which a packet has already been received. When (13) it is determined to make a frame selection decision, a packet is selected (14) and forwarded (15) without waiting for the end of the frame interval.

### FIELD OF THE INVENTION

The present invention relates generally to communication systems and, in particular, to frame selection in communication systems.

### BACKGROUND OF THE INVENTION

In voice communication systems, delays introduced between the speaking user and the listening user(s) can have a real impact on user experience. When the delays are substantial users are forced into unnatural speaking cadences to avoid talking over one another. This can be quite frustrating to users who are not accustomed to communicating in this manner and can make even a short conversation difficult or even burdensome.

ITU-T G.114 specifies that a total 1-way delay of 0-150 milliseconds is acceptable for voice applications. This can be a challenging goal to achieve, particularly in wireless systems where the delay contributed by the Mobile-to-Network and Core-Network components is ˜100 ms. This leaves only 50 ms as the delay budget for the Frame Selection/Voice Codec. Thus, new techniques that are able to reduce delays in frame selection, for example, would clearly be desirable.

### BRIEF DESCRIPTION OF THE DRAWINGS

FIG. 1 is a logic flow diagram of functionality performed by a frame selector in accordance with various embodiments of the present invention.

FIG. 2 is a block diagram depiction of a frame selector in accordance with multiple embodiments of the present invention.

FIG. 3 is a detailed block diagram depiction of a Frame Selection/Voice Codec subsystem (with components related thereto) in accordance with certain embodiments of the present invention.

FIG. 4 is a detailed block diagram depiction of the frame selector subsystem depicted in FIG. 3, in accordance with certain embodiments of the present invention.

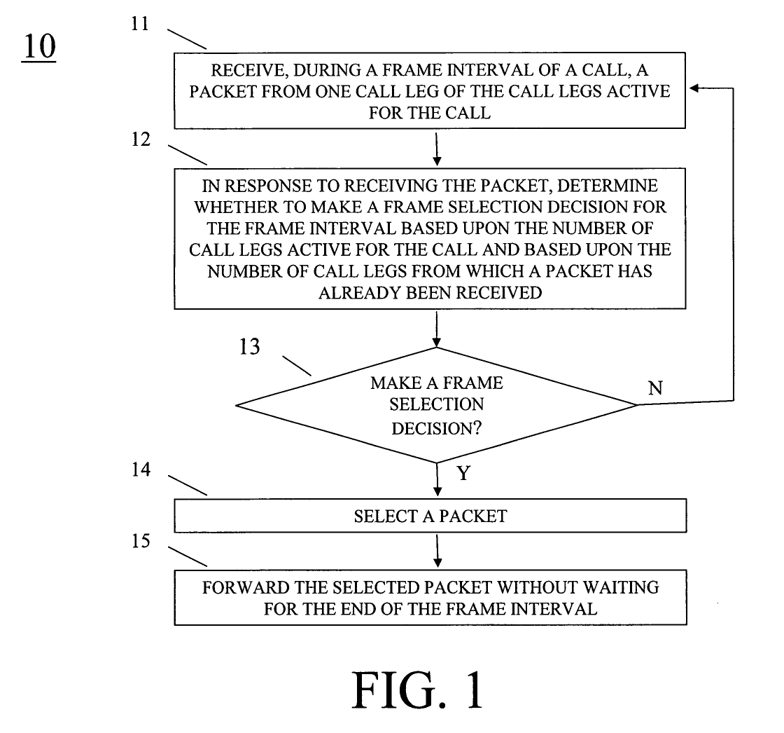

Specific embodiments of the present invention are disclosed below with reference to FIGS. 1-4. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the logic flow diagrams above are described and shown with reference to specific steps performed in a specific order, some of these steps may be omitted or some of these steps may be combined, sub-divided, or reordered without departing from the scope of the claims. Thus, unless specifically indicated, the order and grouping of steps is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### SUMMARY OF THE INVENTION

To address the need for new techniques that are able to reduce delays in frame selection, a method such as that depicted in diagram 10 of FIG. 1 may be employed. A packet from one call leg active for a call is received (11) during a particular frame interval of the call. In response to receiving the packet, a determination (12) is made as to whether to make a frame selection decision for the frame interval. This determination is based upon the number of call legs active for the call and upon the number of call legs for which a packet has already been received. When (13) it is determined to make a frame selection decision, a packet is selected (14) and forwarded (15) without waiting for the end of the frame interval. By performing frame selection in this manner, a packet may be selected and forwarded well before the end of the frame interval, thereby reducing delay.

### DETAILED DESCRIPTION OF EMBODIMENTS

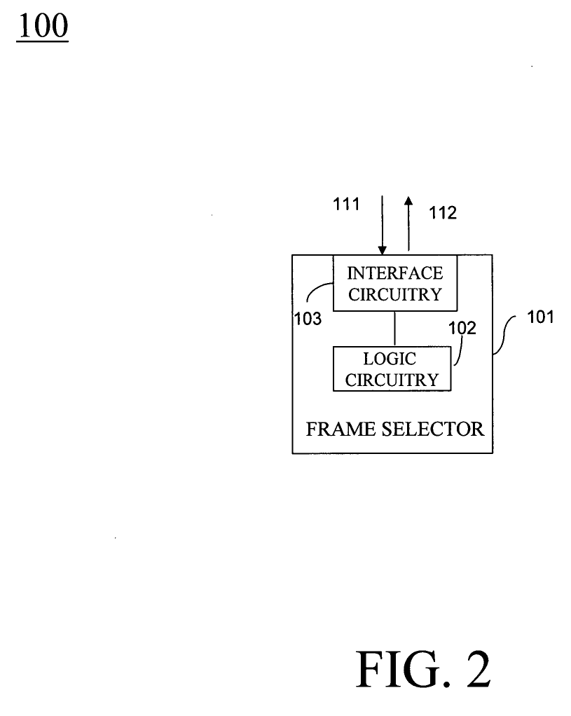

The present invention can be more fully understood with reference to FIGS. 2-4. FIG. 2 is a block diagram depiction of a frame selector in accordance with multiple embodiments of the present invention. In diagram 100, frame selector 101 is depicted as including logic circuitry 102 and interface circuitry 103.

Depending on the embodiment and the design specifics, the interface circuitry may include circuitry to support one or more different interfaces or multiple interfaces of the same type. For example, the interface circuitry may include circuitry to support one or more packet interfaces for sending and receiving packets and one or more management interfaces for communicating with an application processor.

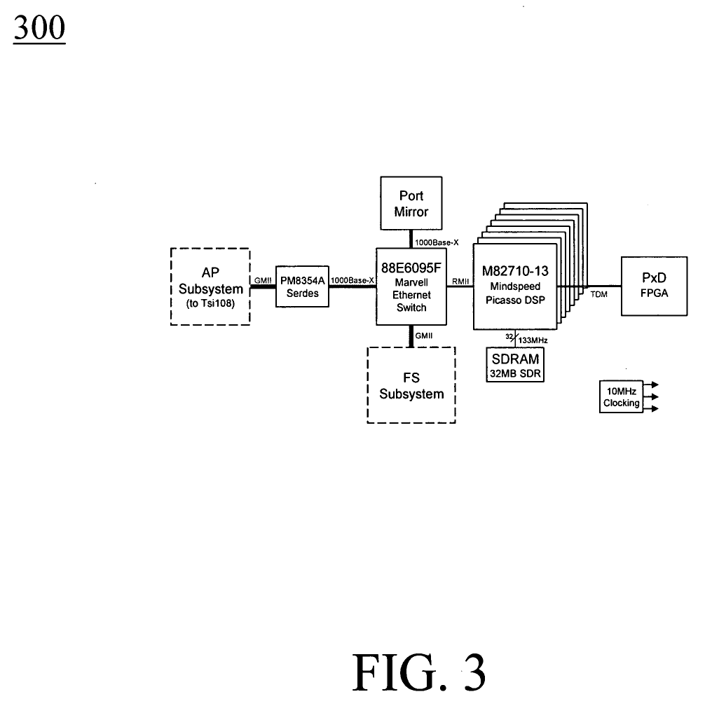

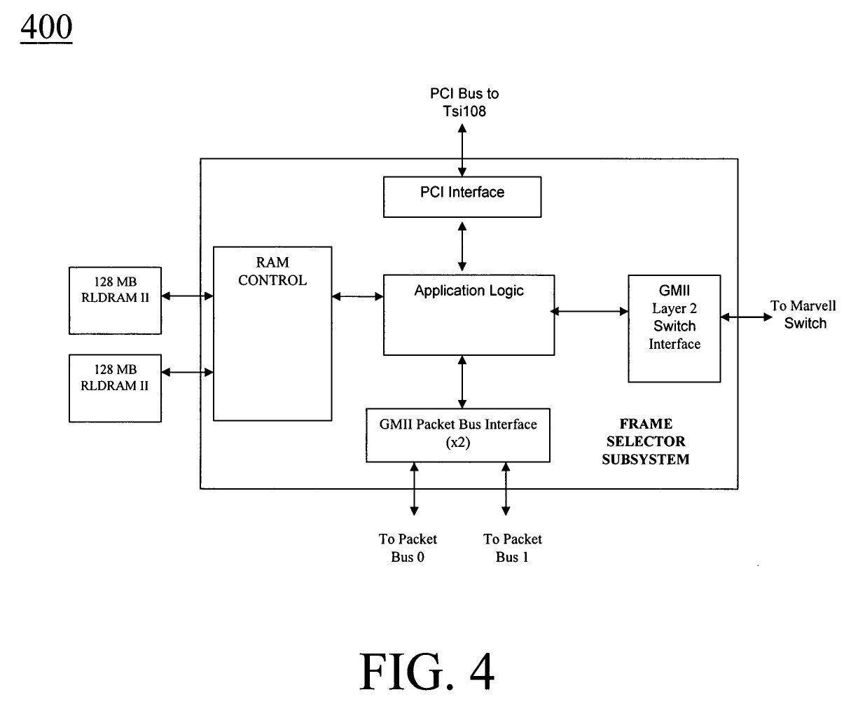

Also depending on the embodiment and the design specifics, the logic circuitry may be realized in whole or in part as a field-programmable gate array (FPGA) or processor. The logic circuitry may also include a memory unit having one or more memory components. Many design options for implementing the logic circuitry of a frame selector are known in the art, and a more detailed example of one specific implementation is provided in FIGS. 3-4.

Interface circuitry and logic circuitry are typically adapted to implement algorithms and/or protocols that have been expressed using high-level design languages or descriptions, expressed using computer instructions, expressed using signaling flow diagrams, and/or expressed using logic flow diagrams.

Thus, given a high-level description, an algorithm, a logic flow, a messaging/signaling flow, and/or a protocol specification, those skilled in the art are aware of the many design and development techniques available to implement logic circuitry that performs the given logic. Therefore, logic circuitry 102 represents a known device that has been adapted, in accordance with the description herein, to implement multiple embodiments of the present invention.

Operation of embodiments in accordance with the present invention occurs substantially as follows, first with reference to diagram 100 in FIG. 2. During a frame interval of a call, logic circuitry 102 via interface circuitry 103 receives a packet 111 from one call leg of a plurality of call legs active for the call. In response to receiving the packet, logic circuitry 102 determines whether to make a frame selection decision for the frame interval based upon the number of call legs active for the call and the number of call legs for which a packet has been received.

Depending on the embodiment, logic circuitry 102 may determine to make a frame selection decision only when a packet has been received for all of the active call legs (i.e., packet 111 is the last packet to arrive from the active call legs for this frame interval). Other alternatives are possible, however. Logic circuitry 102 could determine to make a frame selection decision when the second (or third or fourth . . . ) to last packet arrives, for example. In some embodiments, this could be based on how much time is left in the frame interval or whether the frame interval has expired.

Upon determining to make a frame selection, logic circuitry 102 selects a packet and forwards it via interface circuitry 103. Logic circuitry 102 does not wait for the end of the frame interval but rather forwards selected packet 112 without any unnecessary delay.

To provide a greater degree of detail in making and using various aspects of the present invention, a description of certain, quite specific, embodiments follows for the sake of example with reference to FIGS. 3-4. FIG. 3 is a detailed block diagram depiction of a Frame Selection/Voice Codec subsystem (with components related thereto) in accordance with certain embodiments of the present invention.

In accordance with the embodiments depicted in diagram 300, each of the DSPs makes use of its 100 Mbit/s RMII interface to communicate with the Frame Selector (FS) field-programmable gate array (FPGA) or an MPC7448 application processor via the Marvell Ethernet switch. Each of the DSPs makes use of a TDM port to communicate with the PxD. The DSP subcircuit performs the vocoding of up to 768 EVRC or EVRC-B voice channels.

FIG. 4 is a detailed block diagram depiction of the frame selector subsystem depicted in FIG. 3, in accordance with certain embodiments of the present invention. In accordance with the embodiments depicted in diagram 400, the FS subsystem includes: 2 Packet Bus GigE SERDES interfaces, a Frame Selector FPGA, 256 MB RLDRAM II (2 blocks of 128 MB @200 MHz), a Peripheral Component Interconnect (PCI) Interface, and a Marvell Layer 2 switch interface.

Packets that are bearer frames intended for vocoding are stored temporarily in buffers for each call. Each call can have up to 7 call legs active at the same time. It is one of the jobs of the FS FPGA to collect these incoming call legs, decide which one of the legs was the ‘best’ (as soon as the last call leg is received), and then forward the packet on to the DSPs without delay. The interface from the FS to the DSPs is via a Marvell layer 2 Ethernet switch, and therefore the FS builds RTP/UDP/IP/Ethernet frames and transmits them out the FS's GMII interface to the switch. The DSPs will then vocode (or transcode as the case may be) the voice frames for transmission to the PSTN.

In the reverse direction, frames from the DSPs are transported through the Marvell switch and back through a GMII interface on the FS FPGA. In this direction, the FS needs to strip the RTP/UDP/IP/Ethernet headers off the frames from the DSPs, duplicate the payload, and format a new packet with this payload for each and every active call leg, and send them out the packet bus interface.

Thus, more generally speaking, in this ASAP (As Soon As Possible) frame selection approach the frame selection decision is made at the earliest possible time within the frame interval. The Frame Selector module has knowledge of how many frame candidates (“legs”) it is expecting; therefore, it can make the frame selection decision as soon as the last of the legs has been received, rather than waiting until the end of the frame interval.

Minimally, a frame selection decision should be made for each frame interval (20 ms for CDMA systems). Existing algorithms do not make that decision until the end of the frame interval. Typically, all of the frame candidates (commonly called “legs” of a call) have arrived by the middle of a frame interval. Therefore, with existing approaches an extra 10 ms of delay, on average, is added by the frame selection algorithm.

By deploying the ASAP Frame Selection approach, the delay contributed by frame selection may be reduced from 12-20 ms to 2-10 ms; an average savings of 10 ms or 20% of the 50 ms delay budget allotted for frame selection and transcoding operations. While the frame selection contribution to delay is minimized by ˜20%, it can really translate to a more significant savings of up to 30 ms (˜60%). Since the intervals are quantized to 20 ms, and the frames are transmitted between processing elements (FPGA and DSP) across a localized packet network, missing the scheduled execution time in the downstream element by just a few milliseconds can cause the delay to bump to the next 20 ms interval. Therefore, the small 10 ms reduction in delay at the frame selection stage can lead to an aggregate 25-30 ms reduction in overall system delay, and this can substantially contribute to reducing the 1-way voice delay to be comfortably below the 150 ms delay limit.

The detailed and, at times, very specific description above is provided to effectively enable a person of skill in the art to make, use, and best practice the present invention in view of what is already known in the art. In the examples, specifics are provided for the purpose of illustrating possible embodiments of the present invention and should not be interpreted as restricting or limiting the scope of the broader inventive concepts.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, top and bottom, and the like are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

What is claimed is:

1. A method for frame selection comprising:
receiving, during a frame interval of a call, a packet from one call leg of a plurality of call legs active for the call;
in response to receiving the packet, determining whether to make a frame selection decision for the frame interval based upon a number of call legs active for the call and based upon the number of call legs from which a packet has been received;
when determining to make a frame selection, selecting a packet; and
forwarding the selected packet without waiting for the end of the frame interval.

2. The method as recited in claim 1, wherein determining whether to make a frame selection decision for the frame interval based upon a number of call legs active for the call and based upon the number of call legs for which a packet has been received comprises determining to make a frame selection decision when a packet has been received from all of the call legs active for the call.

3. The method as recited in claim 1, wherein determining, in response to receiving the packet, whether to make a frame selection decision for the frame interval comprises
upon receiving the packet, determining whether to make a frame selection decision for the frame interval.

4. The method as recited in claim 1, wherein, when determining to make a frame selection, selecting a packet comprises
upon determining to make a frame selection, selecting a packet.

5. The method as recited in claim 1, wherein forwarding the selected packet without waiting for the end of the frame interval comprises
upon selecting the packet, forwarding the selected packet.

6. A frame selector comprising:
interface circuitry; and
logic circuitry, coupled to the interface circuitry,
adapted to receive, during a frame interval of a call via the interface circuitry, a packet from one call leg of a plurality of call legs active for the call,
adapted to determine, in response to receiving the packet, whether to make a frame selection decision for the frame interval based upon a number of call legs active for the call and based upon the number of call legs from which a packet has been received,
adapted to select a packet when determining to make a frame selection, and
adapted to forward, via the interface circuitry, the selected packet without waiting for the end of the frame interval.

7. The frame selector as recited in claim 6, wherein the logic circuitry comprises at least a portion of a field-programmable gate array (FPGA).

8. The frame selector as recited in claim 6, wherein the logic circuitry comprises a memory unit.

9. The frame selector as recited in claim 6, wherein the interface circuitry comprises a packet interface.

10. The frame selector as recited in claim 6, wherein the interface circuitry comprises a management interface.

11. The frame selector as recited in claim 10, wherein the management interface comprises a Peripheral Component Interconnect (PCI) bus interface.

12. The frame selector as recited in claim 6, wherein being adapted to determine comprises
being adapted to determine to make a frame selection decision when a packet has been received from all of the call legs active for the call.

13. The frame selector as recited in claim 6, wherein being adapted to determine comprises
being adapted to determine, upon receiving the packet, whether to make a frame selection decision for the frame interval.

14. The frame selector as recited in claim 6, wherein being adapted to select comprises
being adapted to select a packet upon determining to make a frame selection.

15. The frame selector as recited in claim 6, wherein being adapted to forward comprises
being adapted to forward the selected packet upon selecting the packet.
